(19) United States
(12) Patent Application Publication
(10) Pub. No.: US 2006/0112731 A1
(43) Pub. Date: Jun. 1, 2006

(54) OPTICAL LENS MOLDING APPARATUS

(76) Inventor: Mengkun Wang, Taichung (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/907,709

(22) Filed: Apr. 13, 2005

(30) Foreign Application Priority Data
Dec. 1, 2004 (TW) 93137014

(51) Int. Cl. C03B 11/08

(52) U.S. Cl. 65/374.12; 65/374.13

(57) ABSTRACT

An optical lens molding apparatus comprising a first mold core, a second mold core, two internal sleeves and an external sleeve is provided. The first and the second mold core have a first coefficient of thermal expansion. The two internal sleeves are co-axially assembled with the first mold core and the second mold core respectively and have a second coefficient of thermal expansion. Furthermore, the external sleeve has a first inner diameter and a second inner diameter. The first mold core and the second mold core are co-axially assembled into the external sleeve having the first inner diameter such that a cavity is formed between the two mold cores. The two internal sleeves are co-axially assembled into the external sleeve having the second inner diameter. The external sleeve has a third coefficient of thermal expansion smaller than the first and the second coefficient of expansion.

### CROSS-REFERENCE TO RELATED APPLICATION

This application claims the priority benefit of Taiwan application serial no. 93137014, filed on Dec. 1, 2004.

### BACKGROUND OF THE INVENTION

1. Field of the Invention

The present invention relates to an optical lens molding apparatus. More particularly, the present invention relates to an optical lens molding apparatus that reduces optical axis from being tilted and de-centered.

2. Description of the Related Art

Conventionally, the process of fabricating a non-spherical optical lens includes setting up a mold cavity with a mold and a pair of mold cores and then heating a gob of glass inside the mold cavity to soften the glass into whatever shape desired and obtain an optical lens after cooling. In general, small gaps between the mold cores and the mold are provided to ease assembling. However, at a high molding temperature, both the mold and the mold cores will expand leading to larger gaps. As a result, tilting or de-centering of the mold cores may occur and hence the molded optical lens may have a tilted or de-centered optical axis.

FIG. 1 is a schematic cross-sectional view showing the structure of a conventional optical lens molding apparatus. The conventional optical lens molding apparatus 100 in FIG. 1 mainly comprises an upper mold core 110, a lower mold core 120 and an external sleeve 140. The external sleeve 140 has an inner diameter D. The upper mold core 110 and the lower mold core 120 are co-axially assembled into the external sleeve 140 having the inner diameter D such that a cavity 150 is formed between the upper mold core 110 and the lower mold core 120. In addition, the external sleeve 140 has a coefficient of thermal expansion greater than that of both the upper mold core 110 and the lower mold core 120.

To facilitate the process of assembling the upper mold core 110 and the lower mold core 120 with the external sleeve 140, a gap 162 is provided. The process of molding an optical lens requires heating the set of molding apparatus to a temperature of about 525° C. to soften a gob of glass 50 (As shown in FIG. 2A). At such a high temperature environment, the upper mold core 110, the lower mold core 120 and the external sleeve 140 will expand because of the heat. Because the degree of outward expansion of the upper mold core 110 and the lower mold core 120 is less than the degree of outward expansion of the external sleeve 140, the width of the gap 162 will enlarge. Consequently, in the process of pressing the upper mold core 110 downward, tilting or de-centering of the upper mold core 110 may occur due to the enlarged gap 162.

FIGS. 2A and 2B are sketches showing two possible shapes of optical lens molded using a conventional optical lens molding apparatus. As shown in FIGS. 1 and 2A, the optical axis C1 of the upper surface 52 of the molded optical lens 50a will de-center when the upper mold core 110 is de-centered. In other words, there is a quantity of shift δ between the optical axis C1 of the upper surface 52 and the optical axis C2 of the lower surface 54. Thus, the optical lens 50a sustains a de-centered optical axis.

Furthermore, as shown in FIGS. 1 and 2B, the optical axis C2 of the upper surface 52 of the molded optical lens 50a will tilt to the left when the upper mold core 110 is tilted. In other words, the optical axis C1 of the upper surface 52 will form an included angle θ with the optical axis C2 of the lower surface 54. Thus, the optical lens 50a sustains a tilted optical axis.

In brief, due to the high molding temperature and the smaller degree of thermal expansion of the upper mold core and the lower mold core relative to the external sleeve, the gap between the mold cores and the external sleeve will increase. Hence, the tilting or de-centering of the upper mold will easily occur. In other words, the optical lens produced using a conventional molding apparatus is liable to have tilting or de-centering problem. This leads to some difficulties in finding the center in a centering process. The inability to locate the correct position of the optical axis often leads to a significant drop in the yield of assembling products.

### SUMMARY OF THE INVENTION

Accordingly, at least one object of the present invention is to provide an optical lens molding apparatus for minimizing the tilting or de-centering of the optical axis of molded lenses by adding a sleeve between an external sleeve and a mold core. The additional sleeve has a coefficient of thermal expansion greater than that of the external sleeve.

To achieve these and other advantages and in accordance with the purpose of the invention, as embodied and broadly described herein, the invention provides an optical lens molding apparatus. The molding apparatus mainly comprises a first mold core, a second mold core, two internal sleeves and an external sleeve. The first mold core and the second mold core have a first coefficient of thermal expansion. The first mold core and the second mold core are co-axially assembled into the two internal sleeves having a second coefficient of thermal expansion, respectively. The external sleeve has a first inner diameter and a second inner diameter. The first mold core and the second mold core are co-axially assembled into the external sleeve having the first inner diameter such that a mold cavity is formed between the first mold core and the second mold core. The two internal sleeves are co-axially assembled into the external sleeve having the second inner diameter. The external sleeve has a third coefficient of thermal expansion, further the first and the second coefficient of thermal expansion are both greater than the third coefficient of thermal expansion.

In the present invention, two internal sleeves are disposed inside the optical lens molding apparatus. Through a tight fitting of the two internal sleeves to the mold cores, tilting or de-centering of the first mold core at the high temperature environment of a molding process is reduced. Hence, the optical lens molding apparatus can provide a significant improvement to optical axis tilting and de-centering problem.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic cross-sectional view showing the structure of a conventional optical lens molding apparatus.

FIGS. 2A and 2B are sketches showing two possible shapes of optical lens molded using the conventional optical lens molding apparatus.

FIG. 3 is a schematic cross-sectional view showing the structure of an optical lens molding apparatus according to one embodiment of the present invention.

FIGS. 4A through 4D are schematic cross-sectional diagrams showing the steps for forming a molded optical lens using the optical lens molding apparatus of the present invention.

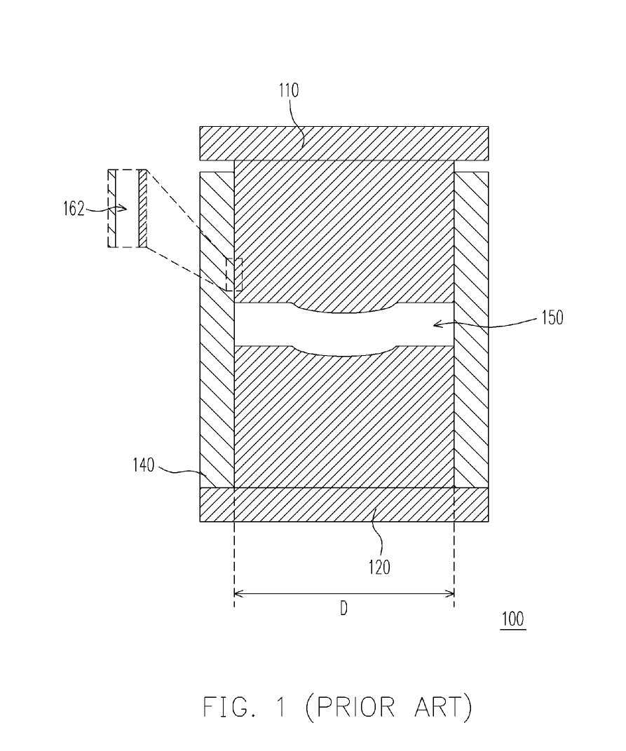

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

FIG. 3 is a schematic cross-sectional view showing the structure of an optical lens molding apparatus according to one embodiment of the present invention. The optical lens molding apparatus of the present invention mainly serves for molding a lump of material into an optical lens. The material to be molded into an optical lens is typically glass or optical polymer. In the present embodiment, the molding material is a gob of glass. However, the material that can be molded by the optical lens molding apparatus is not limited to glass. As shown in FIG. 3, the present embodiment provides an optical lens molding apparatus 200a essentially comprising an upper mold core 210, a lower mold core 220, two internal sleeves 230a, 230b and an external sleeve 240. The upper mold core 210 and the lower mold core 220 have corresponding molding portion 212 and 222 facing each other. The upper mold core 210 and the lower mold core 220 are fabricated using an identical material having a first coefficient of thermal expansion. The two internal sleeves 230a and 230b are co-axially assembled with the upper mold core 210 and the lower mold core 220 individually. The two internal sleeves 230a and 230b have a second coefficient of thermal expansion. The external sleeve 240 has a first inner diameter D1 and a second inner diameter D2. Furthermore, the upper mold core 210 and the lower mold core 220 are co-axially assembled into the external sleeve 240 having the first inner diameter D1 such that a mold cavity 250 is formed between the upper mold core 210 and the lower mold core 220. The two internal sleeves 230a and 230b are co-axially assembled into the external sleeve 240 having the inner diameter D2. In addition, the external sleeve 240 has a third coefficient of thermal expansion and the first and the second coefficient of thermal expansion are both greater than the third coefficient of thermal expansion.

In the aforementioned optical lens molding apparatus 200a, a first gap 262 and a second gap 264 as processing tolerance must be provided between the upper mold core 210, the lower mold core 220 and the external sleeve 240, and between the internal sleeves 230a, 230b and the external sleeve 240 to facilitate assembling of the upper mold core 210, the lower mold core 220, the internal sleeves 230a, 230b and the external sleeve 240. The width of the first gap 262 and of the second gap 264 is about 7˜9 μm, for example.

In the present embodiment, the upper mold core 210 and the lower mold core 220 has a cylindrical body with a first diameter E1 and a second diameter E2 at separate portion respectively. The first diameter E1 is smaller than the second diameter E2. The external sleeve 240 is a hollow sleeve having a first inner diameter D1 and a second inner diameter D2 in two separate portions. The first inner diameter D1 is smaller than the second inner diameter D2. However, the optical lens molding apparatus of the present invention may use a hollow sleeve having only a single inner diameter as an external sleeve. In addition, the internal sleeves 230a, 230b have a ring-shaped body with an inner diameter which is approximately equal to the first diameter E1 of the upper mold core 210 and the lower mold core 220. Further, the outer diameter of the internal sleeves 230a, 230b is approximately equal to the second inner diameter D2 of the external sleeve 240.

In one preferred embodiment of the present invention, the upper mold core 210 and the lower mold core 220 are fabricated using tungsten carbide with a coefficient of thermal expansion of 5.2×10−6/K. The two internal sleeves 230a, 230b are fabricated using stainless steel with a coefficient of thermal expansion of 8.1×10−6/K. Since the internal sleeves 230a, 230b have a coefficient of thermal expansion greater than that of the upper and lower mold core 210, 220, the internal sleeves 230a, 230b have an outward expansion greater than that of the upper and lower mold core 210, 220 under a high temperature environment. Furthermore, the outward expansion of the internal sleeves 230a, 230b is preferably identical with the degree of the outward expansion of the external sleeve 240. In other words, the gap between the internal sleeves 230a, 230b and the external sleeve 240 can be maintained at a constant value between 7˜9 μm throughout the heating process to facilitate subsequent optical lens molding processes.

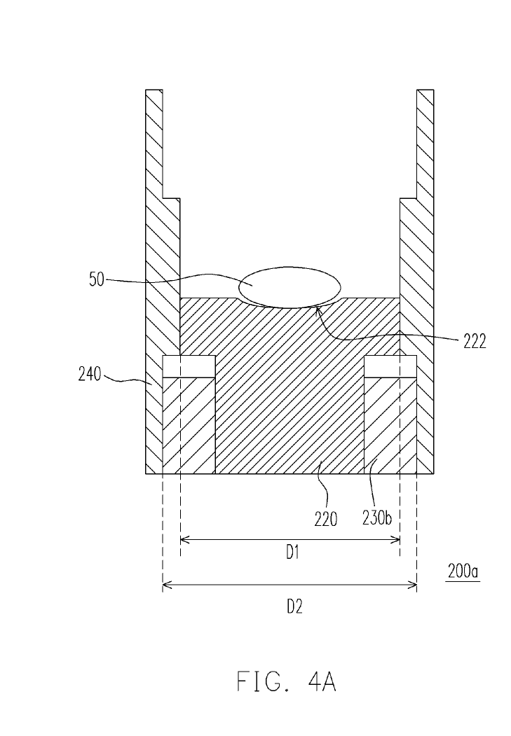

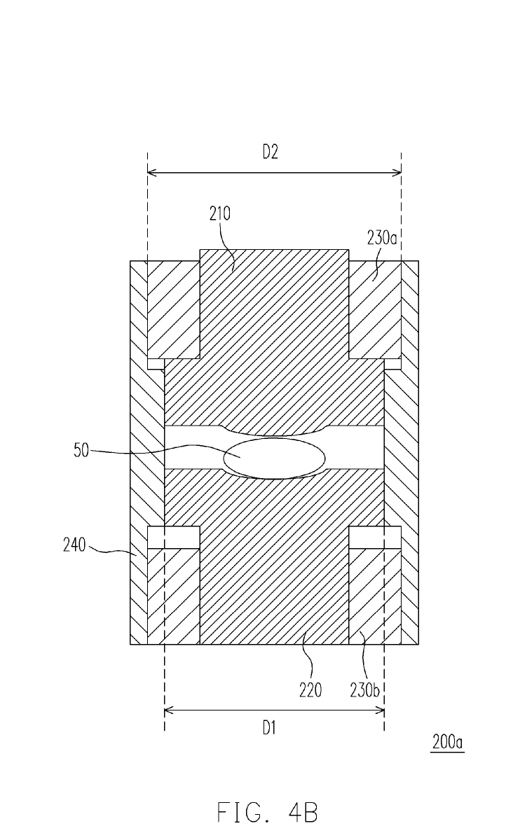

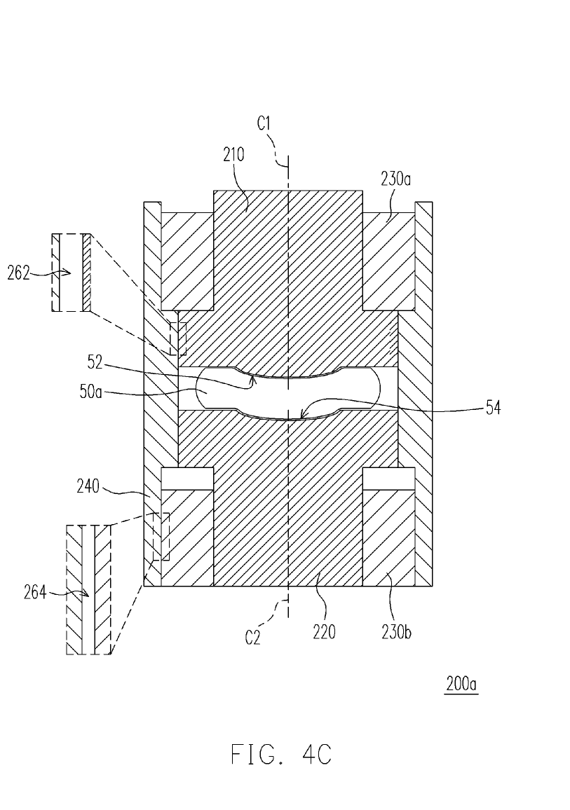

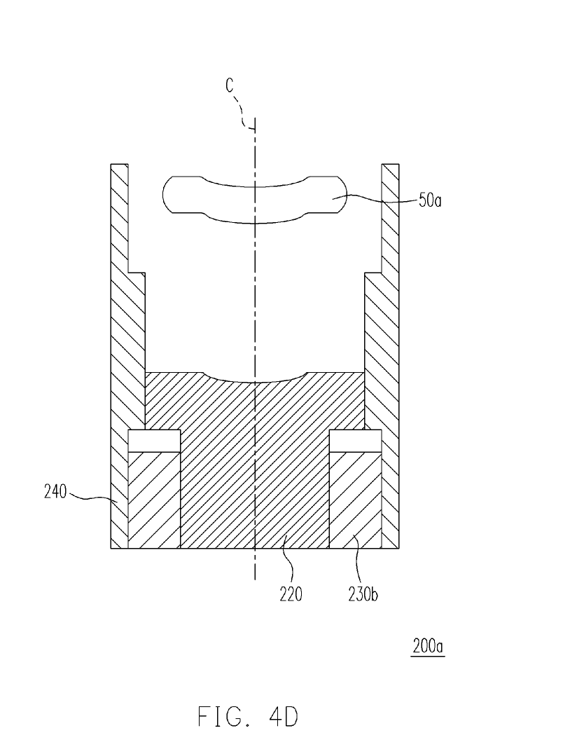

FIGS. 4A through 4D are schematic cross-sectional diagrams showing the steps for forming a molded optical lens using the optical lens molding apparatus of the present invention. As shown in FIG. 4A, the lower mold core 220 is co-axially assembled into the external sleeve 240 having the inner diameter D1 and then the internal sleeve 230b is co-axially assembled into the external sleeve 240 having the second inner diameter D2. Thus, the internal sleeve 230b is disposed between the lower mold core 220 and the external sleeve 240. Thereafter, a gob of glass is disposed on the molding portion 222 of the lower mold core 220.

As shown in FIG. 4B, the upper mold core 210 is co-axially assembled into the external sleeve 240 having the first inner diameter D1 and then the internal sleeve 230a is co-axially assembled into the external sleeve 240 having the second inner diameter D2. Thus, the internal sleeve 230a is disposed between the upper mold core 210 and the external sleeve 240. Thereafter, the upper mold cold 210 is pressed downward gradually to mold the gob of glass into shape. Note that the optical lens molding process is carried out at a high temperature in order to have the gob of glass 50 softened. The temperature in which the molding takes place is about 525° C., for example.

As shown in FIG. 4C, although the width of the first gap 262 between the upper mold core 210, the lower mold core 220 and the external sleeve 240 will increase with the temperature. However, the width of the second gap 264 between the internal sleeves 230a, 230b and the external sleeve 240 can still be maintained about 7˜9 μm because the second coefficient of thermal expansion of the internal sleeves 230a, 230b is greater than both the first and the third coefficient of thermal expansion. Thus, the internal sleeves 230a, 230b are tightly positioned on the upper mold core 210 and the lower mold core 220 individually that the chance of de-centering and tilting the upper mold core 210 or the lower mold core 220 is greatly reduced.

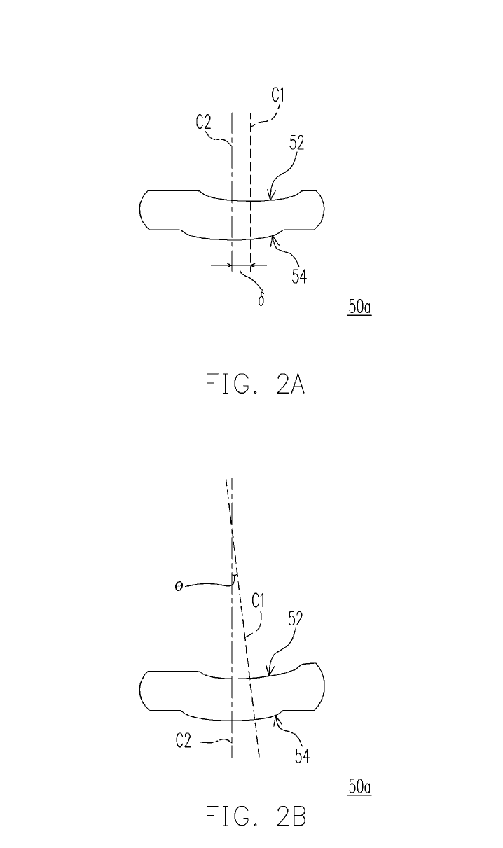

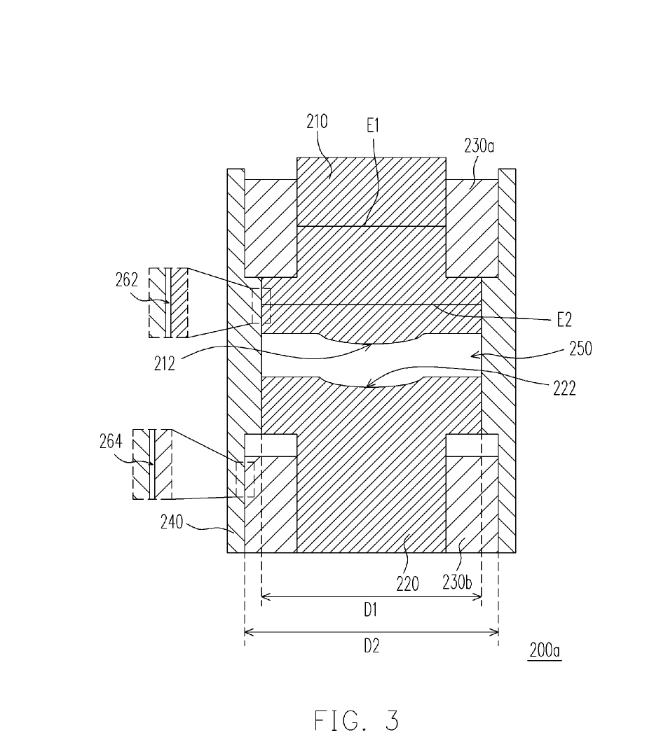

As described, because pressing downward the upper mold core 210 will not cause tilting or de-centering, the amount of de-centering δ (as shown in FIG. 2A) or tilting in the included angle θ between the optical axis C1 of the upper surface and the optical axis C2 of the lower surface of the molded lens 50 is very small. In other words, the optical axis C1 of the upper surface 52 and the optical axis C2 of the lower surface 54 of the optical lens 50a can easily align with the same optical axis C (as shown in FIG. 4D).

Thereafter, as shown in FIG. 4D, the molded optical lens 50a is released from the mold and then a centering process is performed. Since the optical axis tilting or de-centering problem of the optical lens 50a is now minimized, the difficulty in finding the center in the centering process is significantly reduced. Because the correct position of the optical axis C can be easily found, the yield of assembling processes is increased.

It should be noted that the optical lens 50a molded by the optical lens molding apparatus 200a is not limited to a concave/convex type of optical lens shown in FIG. 4D. By changing the molding portion 212, 222 (as shown in FIG. 3) of the upper mold core 210 and the lower mold core 220, other types of optical lenses can be molded. In other words, the molding portion 212, 222 of the upper mold core 210 and the lower mold core 220 can be a concave surface and a convex surface, a pair of concave surfaces or a pair of convex surfaces.

In summary, the two internal sleeves disposed inside the optical lens molding apparatus are utilized to station the closely engaged mold cores (the upper mold core and the lower mold core) so that the degree of tilting or de-centering in the upper mold core at a high temperature is significantly reduced. Thus, the optical lens molding apparatus of the present invention can reduce the optical axis tilting or de-centering problem. As a result, the difficulty in finding the center in a subsequent centering process is minimized. Since the correct position of the optical lens can be readily found, the production yield is therefore increased. In addition, the present invention also provides a means of improving the molding technique of optical lens, a method of producing a molded optical lens that meets the demand of de-centering sensitive applications and a means of molding precision optical lens en-mass.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An optical lens molding apparatus, comprising:
a first mold core having a first molding portion;
a second mold core having a second molding portion facing the first molding portion, wherein the second mold core and the first mold core have a first thermal coefficient of expansion;
two internal sleeves are co-axially assembled with the first mold core and the second mold core and having a second coefficient of expansion; and
an external sleeve having a first inner diameter and a second inner diameter, wherein the first mold core and the second mold core are co-axially assembled into the external sleeve having the first inner diameter such that a mold cavity is formed between the first mold core and the second mold core, the two internal sleeves are co-axially assembled into the external sleeve having the second inner diameter;
wherein the external sleeve has a third coefficient of thermal expansion and the first and the second coefficient of thermal expansion are individually greater than the third coefficient of thermal expansion.

2. The optical lens molding apparatus of claim 1, wherein the second coefficient of thermal expansion is greater than the first coefficient of thermal expansion.

3. The optical lens molding apparatus of claim 1, wherein the first inner diameter is smaller than the second inner diameter.

4. The optical lens molding apparatus of claim 1, wherein the material constituting the first mold core and the second mold core comprises tungsten carbide.

5. The optical lens molding apparatus of claim 1, wherein the material constituting the two internal sleeves comprises stainless steel.

6. The optical lens molding apparatus of claim 1, wherein the first molding portion has a concave surface or a convex surface.

7. The optical lens molding apparatus of claim 1, wherein the second molding portion has a concave surface or a convex surface.
